(19) United States
(12) Patent Application Publication
(10) Pub. No.: US 2023/0277883 A1
(43) Pub. Date: Sep. 7, 2023

(54) INERT GAS FIRE SUPPRESSION SYSTEM FOR MOBILE EQUIPMENT

(71) Applicant: Tyco Fire Products LP, Lansdale, PA (US)

(72) Inventors: Alden Spencer, Marinette, WI (US); Michael John Fisher, Marinette, WI (US); Chad L. Ryczek, Oconto Falls, WI (US)

(73) Assignee: Tyco Fire Products LP, Lansdale, PA (US)

(21) Appl. No.: 18/006,662

(22) PCT Filed: Sep. 10, 2021
(86) PCT No.: PCT/IB2021/058272

§ 371 Date: Jan. 24, 2023

Related U.S. Application Data
(60) Provisional application No. 63/089,231, filed on Oct. 8, 2020.

(51) Int. Cl. A62C 3/16; A62C 3/07; A62C 31/00; A62C 37/44; A62C 99/00; A62C 3/06

(52) U.S. Cl. CPC A62C 3/16; A62C 3/07; A62C 31/005; A62C 37/44; A62C 99/0018; A62C 3/06

(57) ABSTRACT

A vehicle includes electrical equipment and a fire suppression system for the electrical equipment of the vehicle. The fire suppression system includes a sensor, an inert gas storage container, a nozzle, a delivery system, and a controller. The inert gas storage container is configured to store an amount of inert gas and discharge the inert gas based on the fire suppression system being activated. The delivery system includes a flexible conduit. The delivery system is fluidly coupled with the inert gas storage container and the nozzle. The controller is configured to receive sensor signals from the sensor and activate the fire suppression system based on the sensor signals so that the inert gas is provided to the electrical equipment.

### CROSS-REFERENCE TO RELATED APPLICATION

This application claims the benefit of and priority to U.S. Provisional Application No. 63/089,231, filed Oct. 8, 2020, the entire disclosure of which is incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppression agent throughout the area. The fire suppressant agent then suppresses or controls (e.g., prevents the growth of) the fire.

### SUMMARY

One implementation of the present disclosure is a vehicle including electrical equipment and a fire suppression system for the electrical equipment of the vehicle. In some embodiments, the fire suppression system includes a sensor, an inert gas storage container, a nozzle, a delivery system, and a controller. In some embodiments, the inert gas storage container is configured to store an amount of inert gas and discharge the inert gas based on the fire suppression system being activated. In some embodiments, the delivery system includes a flexible conduit. In some embodiments, the delivery system is fluidly coupled with the inert gas storage container and the nozzle. In some embodiments, the controller is configured to receive sensor signals from the sensor and activate the fire suppression system based on the sensor signals so that the inert gas is provided to the electrical equipment.

In some embodiments, the fire suppression system further includes a valve positioned between a first end of the flexible tube and a second end of the flexible tube. In some embodiments, the valve is configured to transition between a closed position and an open position to selectably fluidly couple the inert gas storage container with the nozzle. In some embodiments, the valve is configured to be electronically actuated between the closed position and the open position by the controller.

In some embodiments, the controller is configured to obtain sensor data from the sensor. In some embodiments, the sensor data indicates a fire condition at the electrical equipment.

In some embodiments, the controller is configured to activate the fire suppression system in response to the sensor data indicating a fire condition at the battery compartment. In some embodiments, the sensor is at least one of a temperature sensor or an optical sensor.

In some embodiments, the inert gas includes a nitrogen gas. In some embodiments, the inert gas storage container is fixedly coupled with the mobile equipment through a mount.

In some embodiments, the inert gas storage container is directly fluidly coupled with only the nozzle. In some embodiments, the inert gas storage container and the nozzle are a first inert gas storage container and a first nozzle. In some embodiments, the fire suppression system further includes a second inert gas storage container and a second nozzle fluidly coupled with the second inert gas storage container through another flexible tube. In some embodiments, the second inert gas storage container and the second nozzle are configured to operate independently of the first inert gas storage container and the first nozzle in response to the controller. In some embodiments, the second inert gas storage container and the first inert gas storage container are each configured to provide a pre-engineered amount of the inert gas to the electrical equipment.

In some embodiments, a size of the first inert gas storage container and the second inert gas storage container are pre-engineered to provide a total amount of inert gas to the electrical equipment accounting for a size, geometry, number of vents, hazard temperature, and sea level of a space in which the electrical equipment is disposed. In some embodiments, the total amount of inert gas is configured to reduce an oxygen level of the space to below 15% by volume when the total amount of inert gas is provided into the space.

Another implementation of the present disclosure is a fire suppression system for electrical equipment of mobile equipment, according to some embodiments. In some embodiments, the fire suppression system includes a sensor, a first inert gas storage container, a second inert gas storage container, a nozzle, and a controller. In some embodiments, the first inert gas storage container is configured to store a first amount of inert gas and discharge the first amount inert gas based on the fire suppression system being activated. In some embodiments, the second inert gas storage container is configured to store a second amount of inert gas and discharge the second amount of inert gas based on the fire suppression system being activated. In some embodiments, the nozzle is fluidly coupled with both the first inert gas storage container and the second inert gas storage container in parallel. In some embodiments, the controller is configured to receive sensor signals from the sensor and activate the fire suppression system based on the sensor signals so that the inert gas is provided from the first inert gas storage container and the second inert gas storage container to the electrical equipment through the nozzle.

In some embodiments, the fire suppression system further includes a valve and a flow restriction device. In some embodiments, the valve is positioned between the first inert gas storage container and the nozzle, and the flow restriction device is positioned between the second inert gas storage container and the nozzle.

In some embodiments, the controller is configured to obtain sensor data from the sensor. In some embodiments, the sensor data indicates a fire condition at the electrical equipment. In some embodiments, the controller is configured to activate the fire suppression system in response to the sensor data indicating a fire condition at the battery compartment.

In some embodiments, the first inert gas storage container and the second inert gas storage container are fluidly coupled with the nozzle through flexible tubing. In some embodiments, a size of the first inert gas storage container and the second inert gas storage container are pre-engineered to provide a total amount of inert gas to the electrical equipment accounting for a size, geometry, number of vents, hazard temperature, and sea level of a space in which the electrical equipment is disposed. In some embodiments, the total amount of inert gas is configured to reduce an oxygen level of the space to below 15% by volume when the total amount of inert gas is provided into the space.

Another implementation of the present disclosure is a fire suppression system for an electrical equipment of mobile equipment, according to some embodiments. In some embodiments, the fire suppression system includes a sensor, a first inert gas storage container, a second inert gas storage container, a nozzle, and a controller. In some embodiments, the first inert gas storage container is configured to store a first amount of inert gas and discharge the inert gas based on the fire suppression system being activated. In some embodiments, the second inert gas storage container is configured to store a second amount of inert gas and discharge the second amount of inert gas based on the fire suppression system being activated. In some embodiments, the second inert gas storage container is fluidly coupled with the first inert gas storage container in series. In some embodiments, the nozzle is fluidly coupled with one of the first inert gas storage container or the second inert gas storage container. In some embodiments, the controller is configured to receive sensor signals from the sensor and activate the fire suppression system based on the sensor signals so that the inert gas is provided from the first inert gas storage container and the second inert gas storage container to the electrical equipment through the nozzle.

In some embodiments, a size of the first inert gas storage container and the second inert gas storage container are pre-engineered to provide a total amount of inert gas to the electrical equipment accounting for a size, geometry, number of vents, hazard temperature, and sea level of a space in which the electrical equipment is disposed. In some embodiments, the total amount of inert gas is configured to reduce an oxygen level of the space to below 15% by volume when the total amount of inert gas is provided into the space.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a diagram of an inert gas fire suppression system for mobile equipment, according to an exemplary embodiment;

FIG. 2 is a block diagram of a control system of the inert gas fire suppression system of FIG. 1, according to an exemplary embodiment;

FIG. 3 is a flow diagram of a process for using inert gas to suppress a fire in a battery compartment of mobile equipment, according to an exemplary embodiment; and

FIG. 4 is a perspective view of a mobile vehicle with the inert gas fire suppression system of FIG. 1, according to an exemplary embodiment.

FIG. 5 is a diagram of an inert gas fire suppression system for mobile equipment with each fire suppressant container feeding a single nozzle, according to an exemplary embodiment.

FIG. 6 is a diagram of an inert gas fire suppression system for mobile equipment with multiple fire suppressant containers in parallel feeding a single nozzle, according to an exemplary embodiment.

FIG. 7 is a diagram of an inert gas fire suppression system for mobile equipment with multiple fire suppressant containers in series feeding a single nozzle, according to an exemplary embodiment.

FIG. 8 is a diagram of a coverage area of for cartridges of a fire suppression system for mobile equipment, according to an exemplary embodiment.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, an inert gas fire suppression system is configured for use with mobile equipment. The mobile equipment can be any vehicle, airborne platform, mining vehicle, etc., that may experience vibrations during operation of its respective functions (e.g., transportation across uneven terrain). The inert gas fire suppression system is configured to serve or provide fire suppression for a battery compartment or electrical cabinet that stores one or more battery cells or electrical devices. The battery cells can be Lithium Ion battery cells used by various devices, systems, electric actuators, sub-systems, etc., of the mobile equipment.

The inert gas fire suppression system also includes a controller, a sensor, an inert gas storage container, a valve, flexible hose, and one or more nozzles. The inert gas storage container can be a pressure vessel configured to store an inert gas (e.g., nitrogen) for use in suppressing a fire in the battery compartment or suppressing a fire condition in the battery compartment. The sensor is any of, or a combination of, a temperature sensor, a pressure sensor, a battery temperature sensor, a gas detector, a smoke detector, an optical sensor, etc. The sensor can be positioned within the battery compartment and may be configured to measure temperature, pressure, smoke detection, optical intensity, etc., within the battery compartment or at the battery cells.

The inert gas storage container can be mounted on the mobile equipment through a mount configured to withstand vibrations, shocks, impulses, etc., transferred to the inert gas fire suppression system. The inert gas storage container may store pressurized inert gas. The inert gas may be or include nitrogen gas. The inert gas storage container can include an outlet that fluidly couples with the flexible hose (e.g., a flexible tubular member). The flexible hose extends from the outlet of the inert gas storage container to each of the one or more nozzles to fluidly couple the nozzles with the inert gas storage container. The valve can be positioned along the flexible hose between the outlet of the inert gas storage container and the one or more nozzles. For example, the valve may be positioned at the outlet of the inert gas storage container. The valve can function as an activator for the inert gas fire suppression system and may be configured to transition between a first position or state (e.g., a closed position or state) and a second position or state (e.g., an open position or state). When the valve transitions into the open position, the pressurized inert gas stored in the inert gas storage container may exit the inert gas storage container through the outlet, flow through the flexible hose, and be discharged into the battery compartment through the one or more nozzles. The one or more nozzles can be restricted orifice nozzles and may control a rate at which the inert gas is discharged into the battery compartment. In some embodiments, the one or more nozzles are at least partially positioned within the battery compartment. The one or more nozzles may be fixedly coupled with the battery compartment through mounts (e.g., at an inner surface or inner sidewall of the battery compartment) designed and configured to withstand vibrations introduced to the inert gas fire suppression system through operation of the mobile equipment.

The controller obtains the sensor signals or sensor data from the one or more sensors of the battery compartment and analyzes the sensor signals to determine if a fire condition has occurred at the battery compartment. If a fire condition has occurred at the battery compartment, the controller may generate activation or control signals for the valve and provide the control signals to the valve. The valve receives the control signals and operates to transition into the open position so that the inert gas is discharged through the system and floods the battery compartment.

### Inert Gas Fire Suppression System

Single Cartridge with Multiple Nozzles

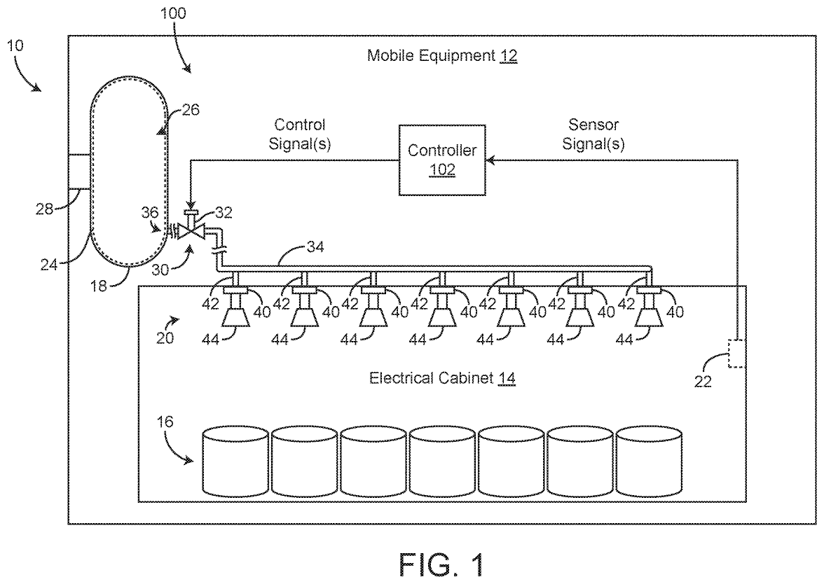

Referring particularly to FIG. 1, an inert gas fire suppression system 10 for mobile equipment 12 is shown, according to an exemplary embodiment. Mobile equipment 12 may be a vehicle, a transportable piece of equipment, a mining vehicle, a straddle carrier, an airborne platform, a room of transportable equipment, a wheeled platform, a motive platform, diesel-electric equipment, etc., or any other equipment that is configured to be transported from one location to another, or may experience vibrations during operation. For example, mobile equipment 12 can be a mining vehicle configured to perform mining operations and may experience vibrations during performing said mining operations.

Inert gas fire suppression system 10 can also include a control system 100 configured to monitor sensor data or sensor signals to identify if a fire event, a fire condition, or a fire has occurred in an electrical cabinet 14 (e.g., a battery area, a space, a zone, an electrical cabinet, a battery compartment, a wiring cabinet, etc., of the mobile equipment 12). Mobile equipment 12 includes electrical cabinet 14 (e.g., a room, an enclosure, an internal space, an engine bay, an energy storage system, etc.). Electrical cabinet 14 can be any area, zone, space, portion, etc., of mobile equipment 12 configured to store an electrical component (e.g., wiring, battery cells, actuators, motors, processing devices, etc.). In some embodiments, electrical cabinet 14 is served by a heating, ventilation, or air-conditioning (HVAC) system configured to maintain a specific temperature, a specific temperature range, or any other desired environmental conditions. Electrical cabinet 14 can be substantially sealed, or may be at least partially vented to atmospheric pressure (e.g., through passive vents and/or active vents that include fans). It should be understood that while mobile equipment 12 is shown including only one electrical cabinet 14, mobile equipment 12 can include any number of electrical cabinets 14 (e.g., 2, 4, 12, etc.). Control system 100 may include a controller 102 configured to monitor fire conditions within each of the electrical cabinets 14 (e.g., based on sensor signal(s) obtained from sensor(s) 22) and operate inert gas fire suppression system 10 to provide inert gas to suppress a fire or arrest fire conditions within each electrical cabinet 14. Control system 100 can operate inert fire suppression system 10 to provide the inert gas to each of the electrical cabinets 14 independently based on fire condition detection or fire detection at each electrical cabinet 14.

It should be understood that, while inert gas fire suppression system 10 is described as serving electrical cabinet 14, inert gas fire suppression system 10 can also be configured to serve or provide fire suppression functionality (e.g., clean-agent inert gas fire suppression) for any vehicle space that is conducive to using a clean agent application (e.g., an engine bay). The agent used by inert gas fire suppression system 10 can be selected using several criteria including fire classification, hazard materials, or volume of space. Inert gas fire suppression system 10 can be generally used in any spaces that require an agent that is electrically non-conductive, leaves no or minimal residue, and does not produce any products of decomposition, while protecting both various devices of the space (e.g., a machine) as well as facilitating operator safety.

Electrical cabinet 14 includes one or more battery cells 16 positioned therewithin (and/or any other electrical components, devices, equipment, etc.). Battery cells 16 can be Lithium Ion batteries, or any other chemical battery configured to store chemical energy that can be converted to electrical energy for use by mobile equipment 12 or various systems, actuators, electric motors, electric devices, sub-systems, etc., of mobile equipment 12.

Referring still to FIG. 1, inert gas fire suppression system 10 can include an inert gas storage container 18 (e.g., a container, a tank, a pressure vessel, a cartridge, etc.). Inert gas storage container 18 includes an inner volume 24 configured to store an inert gas 26. The inert gas 26 can be a nitrogen gas, or a mixture of nitrogen, argon, and carbon dioxide (CO2) gases. For example, the inert gas 26 can be an Inergen® gas mixture that includes 52% nitrogen, 40% argon, and 8% CO2 gases.

Inert gas fire suppression system 10 also includes flexible tubing 34, flexible tubing 42, and nozzles 20. Inert gas fire suppression system 10 may also include a valve 30 configured to transition between a first position and a second position (or a first state and a second state) to selectably fluidly couple inner volume 24 of inert gas storage container 18 with nozzles 20 through flexible tubing 34 and flexible tubing 42. Valve 30 may be electrically actuatable between the first position (e.g., a closed position) and the second position (e.g., an open position) to transition fire suppression system 10 between an activated state and a deactivated state. Valve 30 can include an electric actuator, or an electric motor 32 configured to be driven to transition valve 30 between the first position and the second position. Electric actuator 32 can receive control signals from controller 102 and use the control signal(s) (e.g., activation signals) to transition between the first position and the second position to activate inert gas fire suppression system 10.

Inert gas storage container 18 can include a propellant gas stored within inner volume 24 configured to drive the inert gas 26 to exit inert gas storage container 18 when fire suppression system is activated. In other embodiments, the propellant gas is stored in a separate container or tank selectably fluidly coupled (e.g., through a valve) with the inert gas storage container 18. When inert gas fire suppression system 10 is activated, the inert gas 26 is driven out of inert gas storage container 18 to nozzles 20 of inert gas fire suppression system 10 through flexible tubing 34 and flexible tubing 34. Flexible tubing 42 can be fluidly coupled with valve 30 and outlet 36 of inert gas storage container 18. In this way, the inert gas 26 can be discharged from inert gas storage container 18, through outlet 36, valve 30, flexible tubing 34, and flexible tubing 42 to nozzles 20, where the inert gas 26 can be provided to electrical cabinet 14. Nozzles 20 can each include a restricted orifice 44 and a mount 40. The mount 40 can fixedly couple with a corresponding portion of electrical cabinet 14 (e.g., an inner sidewall, an inner edge, a sidewall, etc.) to provide structural support for nozzles 20 when mobile equipment 12 experiences vibrations.

In some embodiments, inert gas fire suppression system 10 includes multiple nozzles 20 configured to flood electrical cabinet 14 with the inert gas 26. In other embodiments, inert gas fire suppression system 10 includes a single nozzle 20 configured to receive the inert gas 26 from inert gas storage container 18 and flood electrical cabinet 14 with the inert gas 26.

If multiple nozzles are used, each nozzle 20 can receive the inert gas 26 through a corresponding one of flexible tubing 42 that fluidly couples with flexible tubing 34. In some embodiments, flexible tubing 34 and flexible tubing 42 may elastically deform, flex, bend, or otherwise contort without breaking. In this way, flexible tubing 42 and flexible tubing 34 can absorb, bend, or otherwise provide additional structural strength when mobile equipment 12 undergoes vibrations due to its operation (e.g., mining operations, transportation operations, etc.). Other systems that provide fire suppression for batteries of mobile equipment do not use flexible tubing but rather use a configuration similar to a fixed application (e.g., a stationary room). Such systems do not handle vibrations well and the vibrations, shocks, impulses, etc., that can transfer to the system may cause fixed pipes to crack, bend, or plastically deform. Advantageously, inert gas fire suppression system 10 in some embodiments uses flexible tubing to provide a more robust fire suppression system that can withstand jolts, impulses, vibrations, etc., that may occur during operation of mobile equipment 12.

In some embodiments, inert gas storage container 18 is attached, mounted, fixedly coupled, etc., with mobile equipment 12 through a mount 28. Mount 28 can include fasteners, shock absorbers (e.g., rubber mounts), etc., and may be structurally configured to withstand shocks, impulses, vibrations, etc., that mobile equipment 12 may experience during operation. Mount 28 can be specifically tailored to withstand sudden loads, impulses, vibrations, etc., that may occur due to operation of mobile equipment 12. Other systems do not use a mount that is configured to withstand impulses and vibrations present in the application of mobile equipment, and as such, these systems typically undergo failure. Advantageously, inert gas fire suppression system 10 uses mount 28 so that inert gas storage container 18 can withstand the impulses, vibrations, etc., that occur due to operation of mobile equipment 12 without failing. Mounts 40 for nozzles 20 may be similarly constructed to withstand impulses, shocks, vibrations, etc., that may occur due to operation of mobile equipment 12.

Referring still to FIG. 1, inert gas fire suppression system 10 includes one or more sensors 22. Sensor(s) 22 can be or include any temperature sensor, low temperature limiter, smoke detector, infrared sensor, optical sensor, etc., or combination thereof. Sensor(s) 22 can be configured to monitor electrical cabinet 14 to detect various fire conditions. For example, sensor(s) 22 may be configured to detect temperature at one or more locations within electrical cabinet 14 to identify if a fire condition has occurred within electrical cabinet 14. Likewise, sensor signal(s) obtained from sensor(s) 22 can be used to detect if any of battery cells 16 are experiencing thermal runaway (e.g., by analyzing a rate of change of temperature as measured by sensor(s) 22). The battery cells 16 can be any electrical equipment such as processing circuitry, linear electric actuators, battery cells, electric motors, wires, sensors, etc., or any other device that consumes or generates electricity.

Sensor(s) 22 provide the sensor signal(s) to controller 102 for use in determining if fire suppression system 10 should be activated. Controller 102 can analyze the sensor signal(s), and in response to determining that a fire condition is present at electrical cabinet 14 (e.g., a temperature exceeding a threshold value, a rate of change of the temperature exceeding a rate of change threshold, an optical indication of a flame, smoke detection, electrolyte gas detection, or any combination thereof), generate control or activation signals to transition inert gas fire suppression system 10 into the activated state (e.g., by operating valve 30 to transition into the open position). Once inert gas fire suppression system 10 is activated, the inert gas 26 stored in inert gas storage container 18 is discharged into electrical cabinet 14 (e.g., through outlet 36, valve 30, flexible tubing 34, flexible tubing 42, and nozzle 20), thereby flooding electrical cabinet 14 with the inert gas 26 and suppressing the fire or the fire condition.

### One-to-One Cartridge and Nozzle

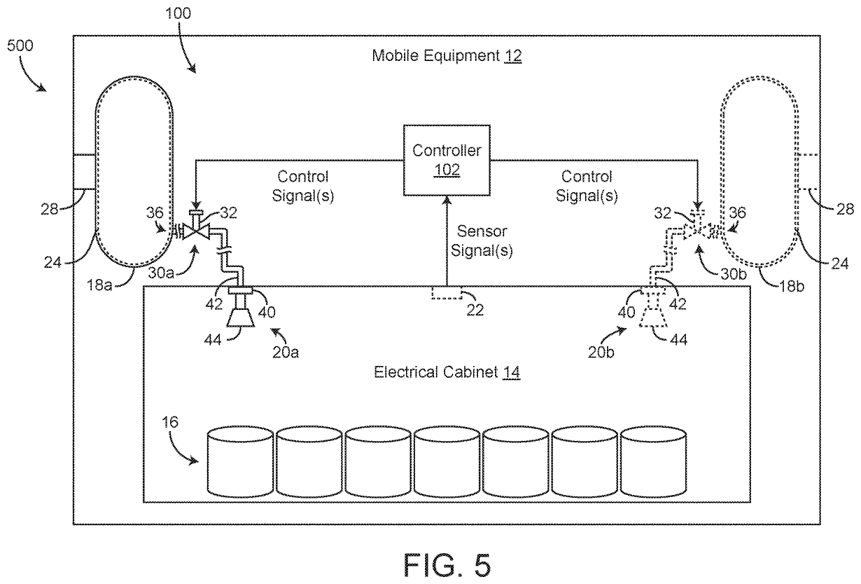

Referring to FIG. 5, the inert gas fire suppression system 10 is shown according to another embodiment, as inert gas fire suppression system 500. The inert gas fire suppression system 500 can be similar to the inert gas fire suppression 10 and may be operated (e.g., by the controller 102, in response to receiving sensor signals, etc.) in a similar or same manner as the inert gas fire suppression system 10. In some embodiments, the inert gas fire suppression system 500 includes similar components as the fire suppression system 10 in a different configuration for providing fire suppression to the electrical cabinet 14 or electrical components thereof.

Referring still to FIG. 5, the inert gas fire suppression system 500 includes a first inert gas storage container 18a, and a second inert gas storage container 18b, according to some embodiments. In some embodiments, the second inert gas storage container 18b is optional and can be installed and used for fire suppression based on a required coverage area or coverage volume for the electrical cabinet 14 and based on a coverage area or coverage volume provided by the first inert gas storage container 18a. For example, if the first inert gas storage container 18a is insufficient to provide the required coverage area or coverage volume for fire suppression of the electrical cabinet 14, the second inert gas storage container 18b may be used to provide sufficient fire suppression for the electrical cabinet 14. It should be understood that while FIG. 5 shows up to two inert gas storage containers 18 used to provide fire suppression to the electrical cabinet 14, any number of inert gas storage containers 18 can be used, as required, to provide adequate or rated fire suppression to the electrical cabinet 14 and battery cells 16 (e.g., electrical components, wires, electric motors, electric linear actuators, processing circuits, etc.) thereof.

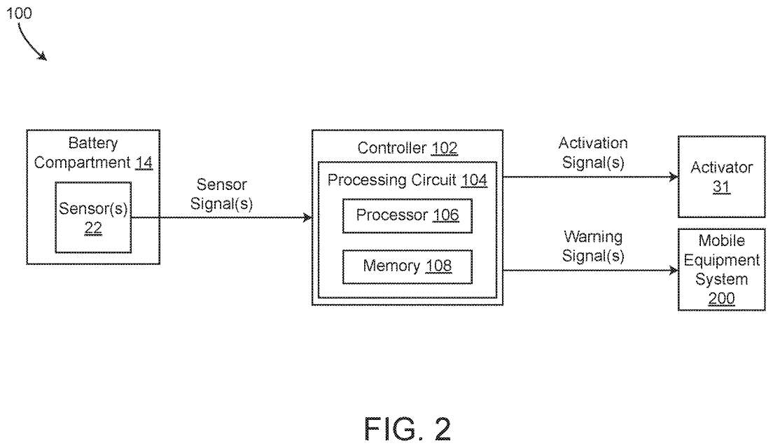

As shown in FIG. 5, the inert gas fire suppression system 500 includes the control system 100 as described in greater detail above with reference to FIG. 1 and in greater detail below with reference to FIG. 2, according to some embodiments. Each of the inert gas fire suppression cartridges 18a and 18b include a corresponding nozzle 20a and 20b, respectively, according to some embodiments. Particularly, the first inert gas storage container 18a is fluidly coupled with the nozzle 20a through a valve 30a, and flexible tubing 42a, and the second inert gas storage container 18b is fluidly coupled with the nozzle 20b through a valve 30b, and flexible tubing 42b, according to some embodiments. In some embodiments, the first inert gas storage container 18a and the second inert gas storage container 18b are directly fluidly coupled with the corresponding first nozzle 20a and the corresponding second nozzle 20b. In this way, each nozzle 20 is fluidly coupled with a single inert gas storage container 18 and vice versa, according to some embodiments.

In some embodiments, the controller 102 is configured to provide control signals to both the first valve 30a and the second valve 30b simultaneously (e.g., in response to receiving the sensor signal(s) from the sensor 22) so that both the first inert gas storage container 18a and the second inert gas storage container 18b discharge inert gas fire suppressant agent into the electrical cabinet 14. In some embodiments, the first inert gas storage container 18a and the second inert gas storage container 18b have a same size, volume, or are configured to store and discharge a same amount of inert gas to the electrical cabinet 14. In some embodiments, the first inert gas storage container 18a and the second inert gas storage container 18b have different sizes. For example, the second inert gas storage container 18b can be a supplemental storage container so that a required amount of inert gas is provided to the electrical cabinet 14. The sizes or storage capacities of either of the first inert gas storage container 18a or the second inert gas storage container 18b can be pre-engineered or determined based on any of, or any combination of, an expected operating or hazard temperature of the electrical cabinet 14 or electrical components thereof, a type of electrical components in the electrical cabinet 14, an area of the electrical cabinet 14, a size of the electrical cabinet 14, a volume of the electrical cabinet 14, an expected pressure at the mobile equipment 12 (e.g., a sea level), a safety factor, a number, size, or position of openings in the electrical cabinet 14, a geometry of the electrical cabinet 14, etc.

In some embodiments, the first inert gas storage container 18a and the second inert gas storage container 18b are both pressurized to a same pressure. For example, the first inert gas storage container 18a and the second inert gas storage container 18b can be pressurized to 2000 psi. The first inert gas storage container 18a and the second inert gas storage container 18b are configured to be operable to discharge in any orientation, according to some embodiments. Advantageously, if the mobile equipment 12 rocks, rolls, tilts, or even rolls over completely, the inert gas fire suppression systems described herein may still be operable to provide fire suppression to the electrical cabinet 14 and electrical components thereof. In some embodiments, any of the fire suppression systems described herein (e.g., the fire suppression system 10, the fire suppression system 500, the fire suppression system 600, etc.) are configured to provide inert gas (e.g., nitrogen) to the electrical cabinet 14 so that the nitrogen becomes at least 45.2% of the atmosphere in the electrical cabinet 14 and/or so that there is below 15% oxygen in the electrical cabinet 14, by volume.

### Multiple Containers in Parallel Feeding Single Nozzle

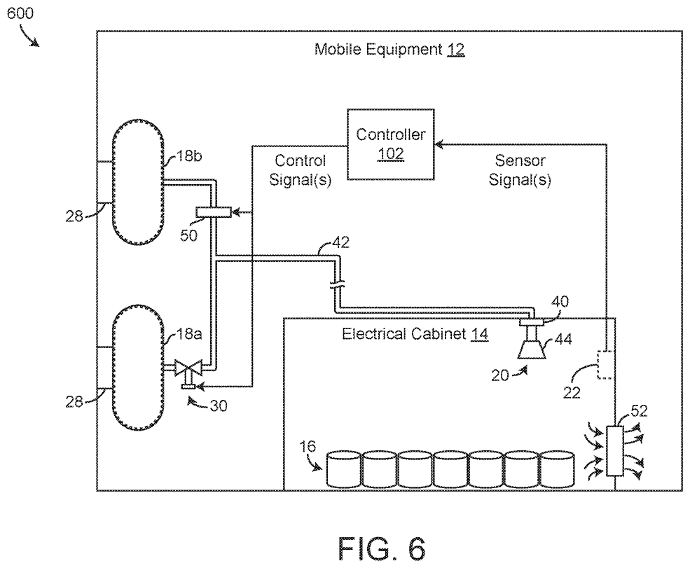

Referring to FIG. 6, the inert gas fire suppression system 10 is shown according to another embodiment, as inert gas fire suppression system 600. The inert gas fire suppression system 600 can be the same as or similar to the inert gas fire suppression system 10 or the inert gas fire suppression system 500 and may be operated (e.g., by the controller 102, in response to receiving sensor signals, etc.) in a similar or same manner as the inert gas fire suppression system 10 or the inert gas fire suppression system 500. In some embodiments, the inert gas fire suppression system 600 includes similar components as the fire suppression system 10 or the fire suppression system 500 but in a different configuration for providing fire suppression to the electrical cabinet 14 or electrical components thereof.

Referring still to FIG. 6, the inert gas fire suppression system 600 includes a first inert gas storage container 18a and a second inert gas storage container 18b both configured to feed a nozzle 20 that is configured to direct, discharge, release, output, etc., the inert gas provided by the first inert gas storage container 18a and the second inert gas storage container 18b to the interior of the electrical cabinet 14 and/or the battery cells 16 (or electrical equipment) thereof. In some embodiments, the electrical cabinet 14 includes an opening 52 through which air may vent (e.g., out of the electrical cabinet 14 as the inert gas is discharged into the electrical cabinet 14). In some embodiments, the first inert gas storage container 18a and the second inert gas storage container 18b are configured to both fluidly couple with the nozzle 20 through the same flexible tubing 42 so that the inert gas from both the first inert gas storage container 18a and the second inert gas storage container 18b is provided into the electrical cabinet 14 through the nozzle 20.

In some embodiments, the first inert storage container 18a is a primary container that is configured to provide a sufficient amount of inert gas to provide fire suppression for the electrical cabinet 14 and batteries 16 or electrical components thereof. In some embodiments, the second inert storage container 18b is a secondary container that is configured to provide an additional amount of inert gas to provide fire suppression for the electrical cabinet 14 and account for the opening 52 (e.g., for inert gas that may leak out of the electrical cabinet 14 through the opening 52).

In some embodiments, a valve 30 is positioned at an outlet of the first inert storage container 18a (e.g., between the outlet of the first inert storage container 18a and the nozzle 20 along the flexible tubing 42) and is operable to control output or discharge of the inert gas from the first inert storage container 18a. In some embodiments, a flow restriction device 50 (e.g., a valve, an electrically controllable valve, a nozzle, an orifice, etc.) is positioned between an outlet of the second inert storage container 18b and the nozzle 20. In some embodiments, both the valve 30 and the flow restriction device 50 are controllable by the controller 102 (e.g., by providing control signals) in response to the controller 102 receiving the sensor signals from the sensor(s) 22. In some embodiments, the controller 102 is configured to provide control signals to both the flow restriction device 50 and the valve 30 simultaneously so that the inert gas that is stored in the first inert gas storage container 18a and the inert gas that is stored in the second inert gas storage container 18b are discharged simultaneously to the electrical cabinet 14 through the nozzle 20 and the flexible tubing 42. In some embodiments, the controller 102 operates the valve 30 to discharge the first inert gas storage container 18a first (e.g., over a first time period) and once an amount of inert gas has been discharged, or once the inert gas has been discharged into the electrical cabinet 14 from the first inert gas storage container 18a for a certain duration, the controller 102 operates the flow restriction device 50 operates the second inert gas storage container 18b to discharge inert gas into the electrical cabinet 14 subsequently.

### Multiple Containers in Series Feeding Single Nozzle

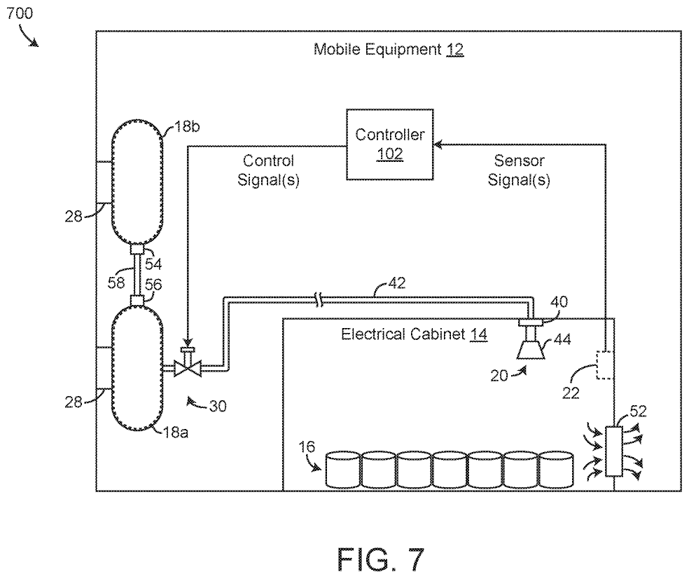

Referring to FIG. 7, the inert gas fire suppression system 10 is shown according to another embodiment, as inert gas fire suppression system 700. The inert gas fire suppression system 700 can be the same as or similar to the inert gas fire suppression system 10, the inert gas fire suppression system 500, or the inert gas fire suppression system 600, and may include similar or the same components. In some embodiments, the inert gas fire suppression system 700 is configured to be operated in a similar or same manner as any of the previously described inert gas fire suppression systems 10, 500, or 600. In some embodiments, the inert gas fire suppression system 700 includes similar or the same components of any of the previously described inert gas fire suppression systems, but the components are arranged in a different configuration.

Referring still to FIG. 7, the inert gas fire suppression system 700 includes a first inert gas container 18a and a second inert gas container 18b that are fluidly coupled in series with each other and fluidly coupled (e.g., selectably fluidly coupled) with the nozzle 20 that is positioned within or configured to discharge the inert gas into the electrical cabinet 14 for fire suppression of the batteries 16 or electrical components thereof. In some embodiments, an outlet 54 of the second inert gas container 18b is fluidly coupled (e.g., through a tubular member, a flexible hose, a flexible pipe, a flexible tubular member, etc., shown as tubular member 58), with an inlet 56 of the first inert gas container 18a. In some embodiments, the first inert gas storage container 18a and the second inert gas storage container 18b are fluidly coupled with each other through an orifice union (e.g., in series as shown in FIG. 7). In some embodiments, the first and second inert gas storage containers 18a and 18b are treated by the controller 102 as a single storage container and the inert gas is released or discharged into the electrical cabinet (e.g., through the flexible tubing 42 and the nozzle 20) by providing control signals to the nozzle 30 (e.g., to transition the nozzle 30 from a closed position to an open position).

### Coverage Area

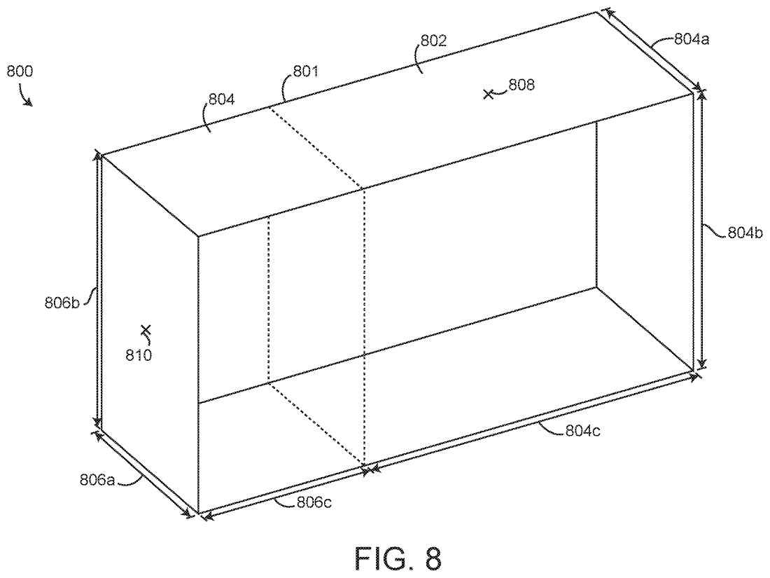

Referring to FIG. 8, a diagram 800 illustrating different coverage areas or volumes for containers of an inert gas are shown, according to some embodiments. Diagram 800 illustrates a volume 801 or a space for which fire suppression (e.g., by providing an inert gas to the volume 801) is desired. In some embodiments, the volume 801 is a space that has a volume V_{space} (e.g., the electrical cabinet 14). In some embodiments, if the volume V_{space} exceeds an amount that can be provided by a single cartridge, the volume V_{space} is divided into sub-sections, each of which correspond to a different cartridge and nozzle. As shown in FIG. 8, the volume 801 is divided into a first sub-volume 802 and a second sub-volume 804, according to some embodiments. In some embodiments, the first sub-volume 802 and the second sub-volume 804 are each serviced by a corresponding nozzle and inert gas container. For example, the first sub-volume 802 may have a nozzle positioned at location 808 to provide inert gas to the first sub-volume 802, and the second sub-volume 804 may have a nozzle positioned at location 810 to provide inert gas to the second sub-volume 804. In some embodiments, the nozzles positioned at the locations 808 and 810 each have a corresponding tank or container of inert gas.

As shown in FIG. 8, the first sub-volume 802 has a depth 804a, a height 804b, and a length 804c. Similarly, the second sub-volume 804 has a depth 806a, a height 806b, and a length 806c. The depth 804a, the height 804b, and the length 804c define a volume V₁ of the first sub-volume 802. The depth 806a, the height 806b, and the length 806c define a volume V₂ of the second sub-volume 804. In some embodiments, a size of the container that fluidly couples with the nozzle for the first sub-volume 802 is designed based on or to match the volume V₁ of the first sub-volume 802. In some embodiments, a size of the container that fluidly couples with the nozzle for the second sub-volume 804 is designed based on or to match the volume V₂ of the second sub-volume 804. For example, the size or capacity of the container that fluidly couples with the nozzle for the first sub-volume 802 can be sufficient so that when the inert gas is discharged into the second sub-volume 804, a certain percentage of the volume V₁ is the inert gas and the oxygen is below a certain level. Similarly, the size or capacity of the container that fluidly couples with the nozzle for the second sub-volume 804, a certain percentage of the volume V₂ is the inert gas and the oxygen is below a certain level.

### Inert Gas Container Design

Referring to FIGS. 1, and 5-7, the size of the inert gas storage containers 18 may be application-specific, and can be tailored based on design parameters to provide adequate fire suppression for a particular or specific space (e.g., a specific electrical cabinet 14). For example, a size and/or number of one or more inert gas storage containers 18 can be determined to provide space-specific inert gas fire suppression for a specific space (e.g., based on design parameters of the specific space).

In some embodiments, a volume of the space (e.g., the electrical cabinet 14) for which fire suppression is desired is estimated. In some embodiments, the volume of the space is used (e.g., by a design controller, processing circuitry, a circuit, an engineer, etc.) to determine an amount of inert gas that should be provided to the space so that a certain percentage of atmosphere in the space is replaced with the inert gas when the amount of inert gas is provided into the space. In some embodiments, the volume of the space is referred to as a hazard volume. In some embodiments, the hazard volume of the space is used to determine the amount or quantity of inert gas that is required. In some embodiments, the amount or quantity of inert gas is determined based on the hazard volume, a lowest anticipated hazard temperature (e.g., a lowest anticipated temperature in the electrical cabinet 14 during normal operating conditions), an altitude of the electrical cabinet 14 above or below sea level, and/or any other geometry of the electrical cabinet 14. In some embodiments, the amount or quantity of inert gas is also determined based on the type of electrical equipment in the electrical cabinet 14. In some embodiments, any of the design parameters described herein (e.g., the hazard volume, the lowest anticipated hazard temperature, the altitude of the electrical cabinet above or below sea level, geometry of the electrical cabinet 14, types of equipment in the electrical cabinet 14, etc.) are assumed for worst case scenario when determining the amount of inert gas that should be provided for fire suppression.

Once the amount of inert gas is determined for providing adequate fire suppression to the electrical cabinet 14, a number and size of inert gas fire suppression containers is determined to contain and discharge the amount of inert gas. In some embodiments, if the amount of inert gas required cannot be contained in a single container, multiple containers are used to provide the inert gas to the electrical cabinet. In this way, the size and number of the inert gas containers can be tailored or configured for specific use with a specific electrical cabinet 14. The configuration of the inert gas containers 18 may be provided according to any of the embodiments described herein with reference to FIGS. 1, 5, 6, or 7 (e.g., a single tank with multiple nozzles, one or more single tanks each with single nozzles, multiple tanks in parallel with a single nozzle, multiple tanks in series with a single nozzle, etc.).

### Control System

Referring now to FIG. 2, control system 100 is shown in greater detail, according to an exemplary embodiment. Control system 100 includes controller 102, sensor(s) 22, an activator 31, and mobile equipment system 200. Controller 102 is configured to receive the sensor signal(s) from sensor(s) 22 and determine if inert gas fire suppression system 10 should be activated based on the received sensor signal(s). In some embodiments, controller 102 is configured to analyze the sensor signal(s) to identify if a fire condition or fire has occurred in the electrical cabinet 14.

Controller 102 is shown to include a processing circuit 104 including a processor 106 and memory 108. Processor 106 may be a general purpose or specific purpose processor, an application specific integrated circuit (ASIC), one or more field programmable gate arrays (FPGAs), a group of processing components, or other suitable processing components. Processor 106 is configured to execute computer code or instructions stored in memory 108 or received from other computer readable media (e.g., CDROM, network storage, a remote server, etc.).

Memory 108 may include one or more devices (e.g., memory units, memory devices, storage devices, etc.) for storing data and/or computer code for completing and/or facilitating the various processes described in the present disclosure. Memory 108 may include random access memory (RAM), read-only memory (ROM), hard drive storage, temporary storage, non-volatile memory, flash memory, optical memory, or any other suitable memory for storing software objects and/or computer instructions. Memory 108 may include database components, object code components, script components, or any other type of information structure for supporting the various activities and information structures described in the present disclosure. Memory 108 may be communicably connected to processor 106 via processing circuit 104 and may include computer code for executing (e.g., by processor 106) one or more processes described herein. When processor 106 executes instructions stored in memory 108, processor 106 generally configures controller 102 (and more particularly processing circuit 104) to complete such activities.

In some embodiments, controller 102 includes a communications interface (e.g., a USB port, a wireless transceiver, etc.) configured to receive and transmit data. The communications interface may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, the communications interface can include a USB port or an Ethernet card and port for sending and receiving data via an Ethernet-based communications link or network. In another example, the communications interface can include a Wi-Fi transceiver for communicating via a wireless communications network or cellular or mobile phone communications transceivers. In some embodiments, the communications interface facilitates wired or wireless communications between controller 102 and sensor(s) 22, activator 31, or mobile equipment system 200.

Referring still to FIG. 2, activator 31 can be valve 30, a puncture device, etc., or any other automatic activation device that can receive activation or control signal(s) from controller 102 and use the control signal(s) to activate inert gas fire suppression system 10. In some embodiments, activator 31 operates to selectably fluidly couple inert gas storage container 18 with electrical cabinet 14 so that electrical cabinet 14 is flooded with inert gas when the fire suppression system 10 is activated. The inert gas may be pressurized when stored within inert gas storage container 18 so that the inert gas is discharged from the inert gas storage container 18 into the electrical cabinet 14 when the inert gas storage container 18 is fluidly coupled with the electrical cabinet 14 (e.g., when valve 30 is transitioned into the open position).

Controller 102 can obtain the sensor signal(s) from sensor(s) 22 and analyze the sensor signal(s) to identify if one or more fire conditions have occurred at the electrical cabinet 14. For example, if sensor 22 is or includes a temperature sensor, controller 102 can compare a detected temperature as obtained by sensor 22 to a corresponding temperature threshold value. If the detected temperature exceeds the corresponding temperature threshold value, controller 102 may determine that a fire condition has occurred at electrical cabinet 14 (e.g., that a fire may be present) and may generate activation signal(s) for activator 31 in response to determining that the fire condition has occurred at electrical cabinet 14.

Controller 102 can be configured to analyze the sensor signal(s) to detect a variety of other fire conditions, including, but not limited to, rise rates (e.g., a rate of change of a detected temperature) that may indicate a fire condition (e.g., if the rise rate exceeds a threshold amount), optical sensor feedback indicating that a flame is present at electrical cabinet 14, smoke detection, electrolyte gas detection, etc., or any other property that can indicate a presence of fire or that a fire is likely to occur at electrical cabinet 14.

In response to detecting the fire condition, controller 102 activates the inert gas fire suppression system 10 so that electrical cabinet 14 is flooded with the inert gas 26. Controller 102 can also provide warning signal(s) to mobile equipment system 200 to notify the mobile equipment system 200 that a fire condition has been detected and/or to notify the mobile equipment system 200 that inert gas fire suppression system 10 has been activated. In some embodiments, the warning signal(s) include deactivation signals for the mobile equipment system 200. For example, the warning signal(s) may include shut-down signals so that the mobile equipment system 200 is shut down if a fire or a fire condition is detected in electrical cabinet 14. Mobile equipment system 200 can be a system of the mobile equipment 12 that uses the battery cells 16 as a power source, or may be any other system of the mobile equipment 12.

In some embodiments, controller 102 is configured to communicate with any of the sensors 22, activator 31 (e.g., valve 30) or the mobile equipment system 200 wirelessly. Additionally, the various systems of mobile equipment 12 can be configured to communicate with each other wirelessly. In some embodiments, different mobile equipment 12 (e.g., in a fleet) are configured to communicate with each other wirelessly to exchange data. Controller 102 can be configured to use a wireless communications protocol that does not interfere with the wireless signals used to communicate between systems of the mobile equipment 12 and/or does not interfere with the wireless signals used to communicate between the mobile equipment 12 of a fleet.

### Process

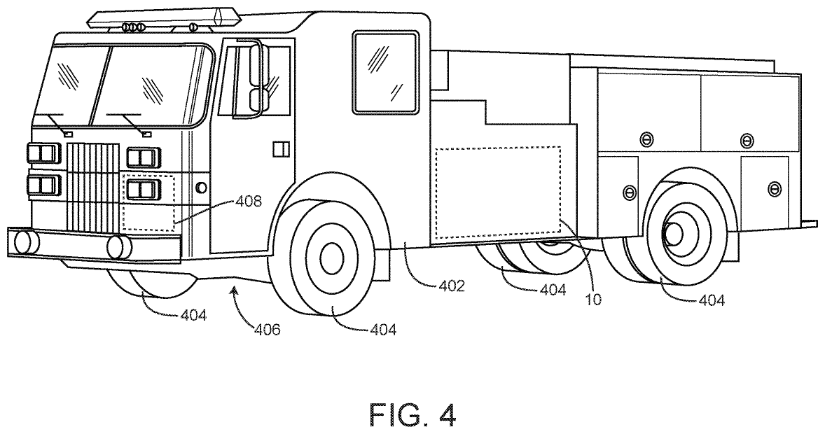

Referring now to FIG. 4, a process 300 for suppressing a fire in an electrical cabinet of mobile equipment is shown, according to an exemplary embodiment. Process 300 can be performed to suppress, extinguish, prevent, or otherwise control a fire or a fire condition. Mobile equipment can be any vehicle (e.g., an off-road vehicle), airborne platform, transportable device, equipment, crane, port, etc., that may experience vibrations due to performing its respective operations (e.g., transportation operations, mining operations, etc.). Process 300 can include steps 302-310 and may be performed using inert gas fire suppression system 10.

Process 300 includes obtaining sensor data from one or more sensors in an electrical cabinet of mobile equipment (step 302), according to some embodiments. Step 302 can be performed by a controller, a processing device, processing circuitry, etc., of an inert gas fire suppression system. Step 302 can include obtaining temperature readings, smoke detection data, optical sensor data, etc., or data from any other sensors that can be used to detect a fire condition at the electrical cabinet. The sensor data may be provided wiredly or wirelessly. For example, the controller 102 may be wiredly electrically coupled with the sensors, or may be configured to communicate with the sensors via a wireless communications protocol (e.g., Bluetooth, LoRa, Zigbee, etc.).

Process 300 includes analyzing the sensor data obtained from the one or more sensors to determine if a fire condition is present at the electrical cabinet (step 304), according to some embodiments. In some embodiments, step 304 is performed by controller 102. Controller 102 may perform step 304 by analyzing the sensor data according to a fire detection algorithm. Controller 102 may compare the sensor data to a corresponding value (e.g., a threshold value), ranges, etc., to identify if the sensor data is within an expected range, below an expected value, etc. If the sensor data is not within the expected range or is above the expected value (e.g., a threshold value), the controller may determine that a fire condition is present at the electrical cabinet. Process 300 proceeds to step 306 in response to detecting that a fire condition is present at the electrical cabinet.

Process 300 includes generating an activation signal for a fire suppression system in response to determining that a fire condition is present at the electrical cabinet (step 306), according to some embodiments. In some embodiments, step 306 is performed by controller 102. Controller 102 can generate a signal for a valve (e.g., an electronic valve such as valve 30) so that the valve operates to open to allow the inert gas to flood the electrical cabinet. It should be understood that step 306 can include generating activation signals for a valve, a rupture device, or any other activating device.

Process 300 includes providing the activation signals to an activator of the fire suppression system (step 308), according to some embodiments. In some embodiments, the activation signals are provided by controller 102 to activator 31 or valve 30 so that the activator 31 or valve 30 operates to activate the fire suppression system. Activating the fire suppression system can include transitioning the valve into the open position so that the inert gas floods the electrical cabinet.

Process 300 includes operating the fire suppression system to flood the electrical cabinet with an inert gas (step 310), according to some embodiments. In some embodiments, step 310 is performed by inert gas fire suppression system 10. For example, step 310 can include opening the valve 30 so that the pressurized inert gas 26 is discharged from inert gas storage container 18, through outlet 36, valve 30, flexible tubing 34, flexible tubing 42, and nozzles 20 to flood electrical cabinet 14. When the inert gas floods the electrical cabinet, the inert gas suppresses any fire or fire conditions that are present. In some embodiments, flooding the electrical cabinet with the inert gas when a fire condition is present facilitates preventing a fire from occurring. In this way, the inert gas fire suppression system 10 can pre-emptively respond to fire conditions to prevent a fire from occurring at electrical cabinet 14.

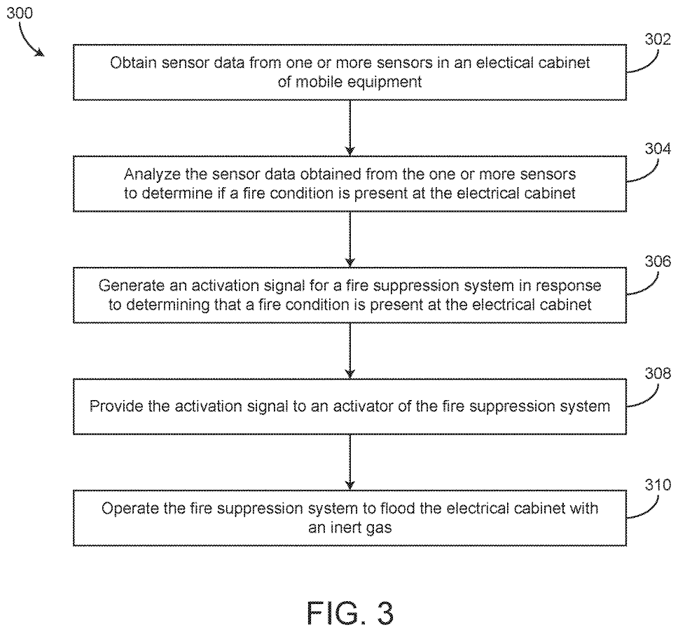

Referring generally to FIGS. 1-3 and 5-7, the inert gas fire suppression system 10 may provide certain advantages over other fire suppression systems for mobile equipment. Other fire suppression systems may not use inert gas to suppress fire at the battery compartment or the electrical cabinet. Advantageously, using inert gas provides improved fire suppression that does not damage electronic components such as battery cells 16.

Other fire suppression systems for mobile equipment may use rigid tubular members to deliver fire suppressant agent to battery cells. However, such configurations may be unsuitable for mobile equipment. Depending on mounting hardware, vibrations may be transferred through the rigid pipes and cause nozzles or various components of the fire suppression system to vibrate, loosen, rattle, and eventually fail. Advantageously, using flexible tubing may reduce a transfer of vibrations to various components of the inert gas fire suppression system 10, thereby providing a more robust fire suppression system with a lower failure rate.

Inert gas fire suppression system 10 also advantageously uses mount 28 and mounts 40 which are designed to meet vibrations that are transferred through inert gas fire suppression system 10 through operation of mobile equipment 12. In some embodiments, mount 28 and mounts 40 are similar to engine mounts and are configured to withstand or absorb vibrations, shocks, impulses, etc., that are transferred to inert gas fire suppression system 10 by mobile equipment 12. Other systems may not use mounting hardware designed to meet vibrations present in mobile equipment applications. Such systems may experience pre-mature wear and failure of detection components, plumbing components, agent tanks, etc.

### Mobile Vehicle

Referring particularly to FIG. 4, inert gas fire suppression system 10 (or alternatively any of the inert gas fire suppression systems 500, 600, or 700) can be configured for use with a mobile vehicle 402. Mobile vehicle 402 may include a plurality of tractive elements 404 (e.g., wheels, tires, treads, etc.) configured to facilitate transportation of mobile vehicle 402. In some embodiments, mobile vehicle 402 includes a chassis 406, and a primary mover 408 (e.g., an internal combustion engine, an electric motor, etc.) configured to generate mechanical power. The tractive elements 404 can be rotatably coupled with the chassis 406. The primary mover 408 may be fixedly coupled, mounted, or otherwise supported by the chassis 406. The tractive elements 404 may be configured to receive the mechanical power through a transmission. In some embodiments, the primary mover of the mobile vehicle 402 is configured to receive electrical energy or electrical power from battery cells 16 of electrical cabinet 14 for use in generating the mechanical power.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A vehicle comprising:
electrical equipment; and
a fire suppression system for the electrical equipment of the vehicle, the fire suppression system comprising:
a sensor;
an inert gas storage container configured to store an amount of inert gas and discharge the inert gas based on the fire suppression system being activated;
a nozzle;
a delivery system including a flexible conduit, the delivery system fluidly coupled with the inert gas storage container and the nozzle; and
a controller configured to receive sensor signals from the sensor and activate the fire suppression system based on the sensor signals so that the inert gas is provided to the electrical equipment.

2. The vehicle of claim 1, wherein the fire suppression system further comprises:
a valve positioned between a first end of the flexible tube and a second end of the flexible tube, wherein the valve is configured to transition between a closed position and an open position to selectably fluidly couple the inert gas storage container with the nozzle.

3. The vehicle of claim 2, wherein the valve is configured to be electronically actuated between the closed position and the open position by the controller.

4. The vehicle of claim 1, wherein the controller is configured to obtain sensor data from the sensor, the sensor data indicating a fire condition at the electrical equipment.

5. The vehicle of claim 4, wherein the controller is configured to activate the fire suppression system in response to the sensor data indicating a fire condition at the battery compartment.

6. The vehicle of claim 1, wherein the sensor is at least one of a temperature sensor or an optical sensor.

7. The vehicle of claim 1, wherein the inert gas includes a nitrogen gas.

8. The vehicle of claim 1, wherein the inert gas storage container is fixedly coupled with the mobile equipment through a mount.

9. The vehicle of claim 1, wherein the inert gas storage container is directly fluidly coupled with only the nozzle, wherein the inert gas storage container and the nozzle are a first inert gas storage container and a first nozzle, wherein the fire suppression system further comprises:
a second inert gas storage container; and
a second nozzle fluidly coupled with the second inert gas storage container through another flexible tube;
wherein the second inert gas storage container and the second nozzle are configured to operate independently of the first inert gas storage container and the first nozzle in response to the controller, wherein the second inert gas storage container and the first inert gas storage container are each configured to provide a pre-engineered amount of the inert gas to the electrical equipment.

10. The vehicle of claim 9, wherein a size of the first inert gas storage container and the second inert gas storage container are pre-engineered to provide a total amount of inert gas to the electrical equipment accounting for a size, geometry, number of vents, hazard temperature, and sea level of a space in which the electrical equipment is disposed.

11. The vehicle of claim 10, wherein the total amount of inert gas is configured to reduce an oxygen level of the space to below 15% by volume when the total amount of inert gas is provided into the space.

12. A fire suppression system for electrical equipment of mobile equipment, the fire suppression system comprising:
a sensor;
a first inert gas storage container configured to store a first amount of inert gas and discharge the first amount inert gas based on the fire suppression system being activated and a second inert gas storage container configured to store a second amount of inert gas and discharge the second amount of inert gas based on the fire suppression system being activated;
a nozzle fluidly coupled with both the first inert gas storage container and the second inert gas storage container in parallel; and
a controller configured to receive sensor signals from the sensor and activate the fire suppression system based on the sensor signals so that the inert gas is provided from the first inert gas storage container and the second inert gas storage container to the electrical equipment through the nozzle.

13. The fire suppression system of claim 12, further comprising a valve and a flow restriction device, wherein the valve is positioned between the first inert gas storage container and the nozzle, and the flow restriction device is positioned between the second inert gas storage container and the nozzle.

14. The fire suppression system of claim 12, wherein the controller is configured to obtain sensor data from the sensor, the sensor data indicating a fire condition at the electrical equipment, and activate the fire suppression system in response to the sensor data indicating a fire condition at the battery compartment.

15. The fire suppression system of claim 12, wherein the first inert gas storage container and the second inert gas storage container are fluidly coupled with the nozzle through flexible tubing.

16. The fire suppression system of claim 12, wherein a size of the first inert gas storage container and the second inert gas storage container are pre-engineered to provide a total amount of inert gas to the electrical equipment accounting for a size, geometry, number of vents, hazard temperature, and sea level of a space in which the electrical equipment is disposed.

17. The fire suppression system of claim 16, wherein the total amount of inert gas is configured to reduce an oxygen level of the space to below 15% by volume when the total amount of inert gas is provided into the space.

18. A fire suppression system for an electrical equipment of mobile equipment, the fire suppression system comprising:
a sensor;
a first inert gas storage container configured to store a first amount of inert gas and discharge the inert gas based on the fire suppression system being activated and a second inert gas storage container configured to store a second amount of inert gas and discharge the second amount of inert gas based on the fire suppression system being activated, wherein the second inert gas storage container is fluidly coupled with the first inert gas storage container in series;
a nozzle fluidly coupled with one of the first inert gas storage container or the second inert gas storage container; and
a controller configured to receive sensor signals from the sensor and activate the fire suppression system based on the sensor signals so that the inert gas is provided from the first inert gas storage container and the second inert gas storage container to the electrical equipment through the nozzle.

19. The fire suppression system of claim 18, wherein a size of the first inert gas storage container and the second inert gas storage container are pre-engineered to provide a total amount of inert gas to the electrical equipment accounting for a size, geometry, number of vents, hazard temperature, and sea level of a space in which the electrical equipment is disposed.

20. The fire suppression system of claim 19, wherein the total amount of inert gas is configured to reduce an oxygen level of the space to below 15% by volume when the total amount of inert gas is provided into the space.
